(19) United States
(12) Patent Application Publication
(10) Pub. No.: US 2021/0253453 A1
(43) Pub. Date: Aug. 19, 2021

(54) Magnetizing Device and Method for Preparing Magnetized Water for Dust Fall of Underground Coal Mine

(71) Applicant: China University of Mining and Technology, Xuzhou (CN)

(72) Inventors: Botao QIN, Xuzhou (CN); Qun ZHOU, Xuzhou (CN); Jun WANG, Xuzhou (CN); Hongjun LIANG, Xuzhou (CN); Anliang WANG, Xuzhou (CN); Ang GAO, Xuzhou (CN); Yuan GAO, Xuzhou (CN); Jin HOU, Xuzhou (CN)

(21) Appl. No.: 16/063,741

(22) PCT Filed: Aug. 19, 2017
(86) PCT No.: PCT/CN2017/098184

§ 371 Date: Apr. 8, 2021

(30) Foreign Application Priority Data
Jun. 7, 2017 (CN) 201710421116.6

(51) Int. Cl. C02F 1/48

(52) U.S. Cl. CPC C02F 1/482; C02F 2201/48

(57) ABSTRACT

The disclosure claims a magnetizing device and method for preparing magnetized water for dust fall of an underground coal mine. The device is formed by a plurality of magnetic drums in a parallel connection with connecting elbows in a “U”-shaped arrangement manner. Each magnetic drum consists of an external magnet, an internal magnet, a hollow pressure pipe, a spiral blade, a screen magnet cover, a connecting steel column, a pressure pipe, a closed nut and a flange plate. According to the disclosure, the internal and external magnets are arranged on a spiral flow channel consisting of the hollow pressure pipe, the spiral blade and the pressure blade by means of an alternating arrangement, thereby building an efficient magnetization environment combined by pulse cutting magnetization and spiral turbulence, enabling that the water for dust fall flowing through is magnetized continuously and efficiently.

### TECHNICAL FIELD

The disclosure relates to the field of technical equipment of dust removal in a mine, and in particular to a magnetizing device and method for preparing magnetized water for dust fall of an underground coal mine.

### BACKGROUND ART

Coal is the main energy source of China. But, 95% of coal mining in China is conducted underground. With continuous improvement of a mining mechanization level, the quantity of dust of an underground coal mine is increasingly increased, and especially in a production operation process of a working face, the dust concentration usually reaches up to 2000 mg/m3 above, which greatly threatens physical and mental health of underground workers and safety production in the mine. Currently, the common dust fall measures in the pit mainly include a water spray and dust fall technology, such as coal seam water injection and high-pressure spray, but due to characteristics of high surface tension of water and high hydrophobicity of coal dust, the existing wet dust fall technology could not meet the requirement of mine dust-proofing. To enhance wettability of water to the coal dust by changing physicochemical property of the water, people pay an increasing attention to water magnetization technology. Research shows that the magnetization could make the physicochemical property of the water change, thereby enhancing the wettability of the water, and then improving the water spray and dust fall efficiency remarkably. Although the magnetization of a magnetic field could enhance the wetting and dust fall performance of water solution, most of existing magnetizers are mainly applied to a water purification treatment field, rather than improving the wetting performance of the solution as a technical evaluation index, such as patents CN201310377032.9 and CN200810172164.7; and meanwhile, the magnetizing device in the above patents generally adopts a straight-through magnetization structure and a magnetization mode with a single direction, which easily causes that the formed magnetic field has imbalanced intensity and instable operation, thereby failing to effectively improve the wetting performance of the solution and to effectively improve the wetting performance of water for spray and dust fall.

### SUMMARY OF THE DISCLOSURE

The technical problem to be solved by the disclosure is to overcome the existing technical defects. In view of existing deficiencies of the existing magnetizing device and method, a magnetizing device and method for preparing magnetized water for dust fall of an underground coal mine, which has characteristics of stable magnetic field intensity, high magnetization efficiency, intrinsic safety and convenient installation and application and can effectively improve the wetting performance of the water for dust fall of the underground coal mine and improve the wet-type spray and dust fall efficiency is provided to reduce the dust concentration of main dust producing points of the mine and improve the dust fall efficiency.

To achieve the above purpose, the magnetizing device for preparing magnetized water for dust fall of the underground coal mine comprises a magnetic drum, a water outlet and a water inlet, wherein the magnetic drum comprises a pressure pipe, a flange plate, an external magnet, an internal magnet, a hollow pressure pipe, a spiral blade, a connecting steel column and a closed nut; the flange plate is welded at the two ends of the magnetic drum; the pressure pipe is connected to the water outlet and the water inlet through the flange plate respectively; and the water outlet and the water inlet are connected to a water inlet and outlet pipe for dust fall through a quick coupling for a mine respectively;

The external magnet is arranged on the outer wall of the pressure pipe; the outer walls at the two ends of the hollow pressure pipe are fixed with the inner wall of the pressure pipe through the connecting steel column by welding; the spiral blade is pasted on the inner wall of the pressure pipe, and welded with the hollow pressure pipe; and the internal magnet is closed inside the hollow pressure pipe, and the two ends of the hollow pressure pipe are closed with the closed nut.

Further, the magnetic drum is n (plural), and divided into two rows; the water outlet is connected to one end of each of the first row of magnetic drums through a connecting elbow; the water inlet is connected to one end of each of the second row of magnetic drums through the connecting elbow; the other end of each of the first row of magnetic drums is respectively connected to the other end of each of the second row of magnetic drums through one connecting elbow, and the magnetic drums are arranged in a “U”-shaped manner in parallel; and valves are arranged at one end of the magnetic drum connected to the water outlet and the water inlet through the connecting elbow.

Further, the number n of the magnetic drum is more than or equal to 4, and is an even number; and the magnetic drum has a length of 1.3 m to 1.8 m.

Further, the thread pitch d of the spiral blade is more than or equal to 50 mm, and the spiral blade clings to the inner wall of the pressure pipe and is welded with the stainless steel hollow pressure pipe in a closed manner. Of course, the thread pitch could be appropriately increased according to an actual need and a size of water flow.

Further, the hollow pressure pipe is made of 304# stainless steel and welded with the pressure pipe by virtue of the “V”-shaped connecting steel column; and the internal threads are provided at the two ends of the hollow pressure pipe, and closed with the closed nut.

Further, the pressure pipe is made of 304# stainless steel.

Further, the exterior of the magnetic drum is wrapped by a metal magnetic shield cover; and the external magnet is located between the magnetic shield cover and the pressure pipe.

Further, the external magnet is arranged around the pressure pipe alternately; and the internal magnet is closed in the hollow pressure pipe and arranged in a crisscross manner.

The disclosure further provides a magnetizing method using the magnetizing device for preparing magnetized water for dust fall of the underground coal mine, comprising the following steps:

A. water for dust fall is fed in the water inlet and flowed into the pressure pipe, and water flow is controlled by controlling the valves;

B. the hollow pressure pipe, the spiral blade and the pressure pipe build a screw-propelled water magnetizing channel to uniformly magnetize the water; and a magnetic field environment formed by the internal magnet and the external magnet in a staggered arrangement manner and having alternate intensity performs continuous pulse cutting magnetization to water; and

C. the water for dust fall outflows through the water outlet.

Further, the intensity of the magnetic field environment formed by the internal magnet and the external magnet is 300 mT-350 mT.

The disclosure has beneficial effects that:

(1) The magnetizing device designed in the disclosure consists of a plurality of magnetic drums, and the number and an installation way of the magnetic drum could be adjusted according to a volume and quality of treated water, so that the magnetizing device has the best magnetization effect on the water for dust fall. No moving parts are provided inside the magnetizing device, so, an external force is not needed. Therefore, the device has high safety coefficient when being used in the underground coal mine, and is applied to a gaseous mine;

(2) The internal and external magnets included in the interior of the magnetic drum adopted by the disclosure are placed around the spiral water channel in a staggered arrangement manner, a high stable pulse magnetic field environment is formed in the magnetic drum and has magnetic field intensity reaching 300-350 mT, and the water for dust fall flowing through is subjected to alternate pulse cutting magnetization, thereby aggravating the molecular motion in the solution, facilitating the breakage of intermolecular hydrogen bonds in the solution, and enhancing the dust wetting performance of the water for dust fall;

(3) The thread pitch d of the spiral blade in the disclosure is more than or equal to 50 mm, and the spiral blade clings to the inner wall of the pressure pipe and is welded with the hollow pressure pipe in a closed manner, thereby forming a spiral water channel. This channel and the magnetic field formed by the internal and external magnets jointly forms a screw-propelled water magnetizing channel which has longer the magnetic course when compared to a straight-through magnetization channel; and the turbulence of water solution flowing through is enhanced, and the uniform magnetization of the water solution is performed more easily;

(4) The internal threads are provided at the two ends of the hollow pressure pipe designed in the disclosure, and the magnets arranged inside can be adjusted according to the nature of the water for dust fall of the underground coal mine, to achieve the purpose of adjusting the pulse cutting of the magnetic field environment;

(5) The magnetizing device designed in the disclosure adopts the efficient magnetizing method combining the pulse cutting magnetization and spiral turbulence coupling. With this method, the magnetization efficiency of the solution is higher, the magnetic field is more stable and the magnetizing time is longer when compared to a straight-through unidirectional magnetizing method.

### DESCRIPTION OF THE DRAWINGS

FIG. 1 is a front view of Embodiment I of the disclosure;

FIG. 2 is a top view of Embodiment I of the disclosure;

FIG. 3 is a sectional view of Embodiment I of the disclosure along an A-A direction;

FIG. 4 is a diagram of a spiral structure inside a magnetic drum;

FIG. 5 is a sectional view for arrangement of an internal magnet and an external magnet inside the magnetic drum;

FIG. 6 is a side view for arrangement of an external magnet inside the magnetic drum;

FIG. 7 is a distribution diagram of a magnetic induction line on the B-B section of the magnetic drum;

FIG. 8 is a distribution diagram of a magnetic induction line on the C-C section of the magnetic drum;

FIG. 9 is a distribution diagram of a magnetic induction line on the whole section of the magnetic drum;

FIG. 10 is a top view of Embodiment II of the disclosure;

In the Figure: 1. Magnetic drum, 2. Pressure pipe, 3. Flange plate, 4, 8, 10, 11. Valve, 5. Water outlet, 6. Quick coupling for mine, 7. Connecting elbow, 9. Water inlet, 12. External magnet, 13. Internal magnet, 14. Magnetic shield cover, 15. Hollow pressure pipe, 16. Spiral blade, 17. Closed nut, 18. Connecting steel column, 19. Magnetic field environment.

### DETAILED DESCRIPTION OF THE PREFERRED EMBODIMENTS

Further description is made below to the disclosure in combination with the drawings.

### Embodiment I

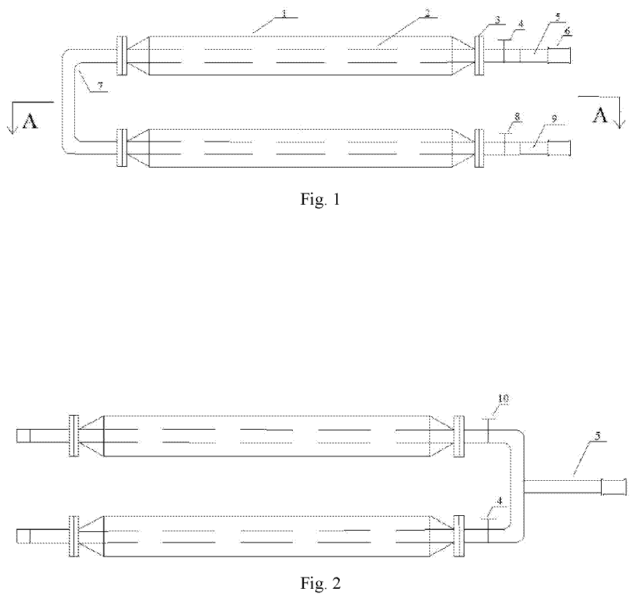

As shown in FIGS. 1-3, a magnetizing device for preparing magnetized water for dust fall of an underground coal mine, comprises a magnetic drum 1, a water outlet 5 and a water inlet 9, wherein the magnetic drum 1 comprises a pressure pipe 2, a flange plate 3, an external magnet 12, an internal magnet 13, a hollow pressure pipe 15, a spiral blade 16, a connecting steel column 18 and a closed nut 17;

The number of the magnetic drum 1 is four, and the magnetic drum has a length of 1.5 m and is divided into two rows; the flange plate 3 is welded at the two ends of the magnetic drum 1; the water outlet 5 is connected to one end of two of the first row of magnetic drums 1 through a connecting elbow 7 respectively; the water inlet 9 is connected to one end of two of the second row of magnetic drums 1 through the connecting elbow 7 respectively; the other end of two of the first row of magnetic drums 1 is respectively connected to the other end of two of the second row of magnetic drums 1 through one connecting elbow 7, and the magnetic drums are arranged in a “U”-shaped manner in parallel; and valves 4, 8, 10, 11 are arranged at one end of the magnetic drum 1 connected to the water outlet 5 and the water inlet 9 through the connecting elbow 7; the water outlet 5 and the water inlet 9 are connected to a water inlet and outlet pipe for dust fall through a quick coupling 6 for mine respectively; and the number of the magnetic drum 1 can be increased according to the water flow and need of magnetization or the adjustment is achieved by controlling the valves 4, 8, 10, 11 arranged on the channel in a “U”-shaped manner.

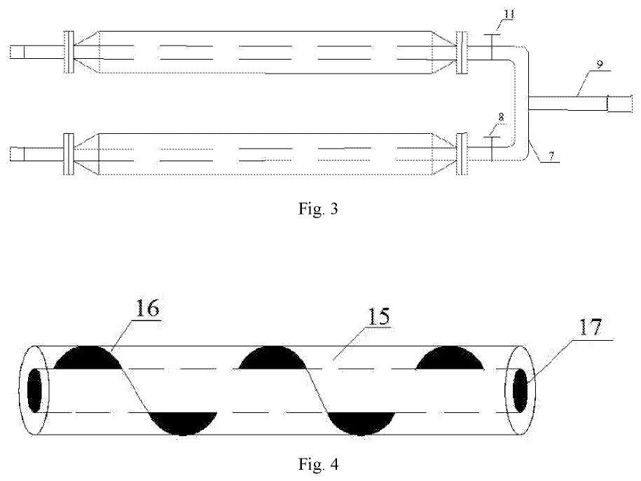

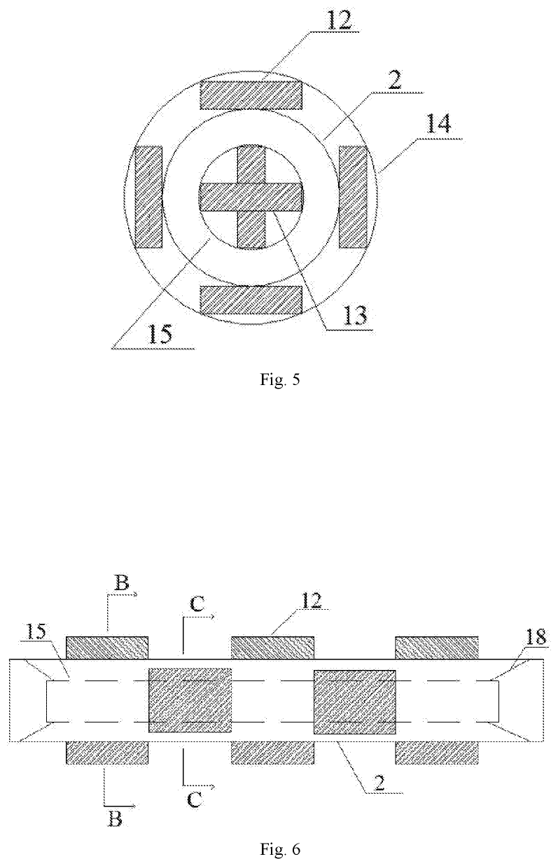

As shown in FIGS. 4-6, the outer wall of the pressure pipe 2 is wrapped by a magnetic shield cover 14, and the external magnet 12 is located between the magnetic shield cover 14 and the pressure pipe 2 alternately; the pressure pipe 2 is made of 304# stainless steel; the internal magnet 13 is closed in the hollow pressure pipe 15 and arranged in a crisscross manner; the hollow pressure pipe 15 is made of 304# stainless steel, and welded to the pressure pipe 2 using the “V”-shaped connecting steel column 18; internal threads are provided at the two ends of the hollow pressure pipe 15, and closed with the closed nut 17; and the spiral blade 16 is pasted on the inner wall of the pressure pipe 2, has a thread pitch d of 50 mm, and is welded with the hollow pressure pipe 15 in a closed manner.

The disclosure further provides a magnetizing method using the magnetizing device for preparing magnetized water for dust fall of the underground coal mine, comprising the following steps:

A. water for dust fall is fed in the water inlet 9 and flowed into the pressure pipe 2, and water flow is controlled by controlling the valves 4, 8, 10, 11;

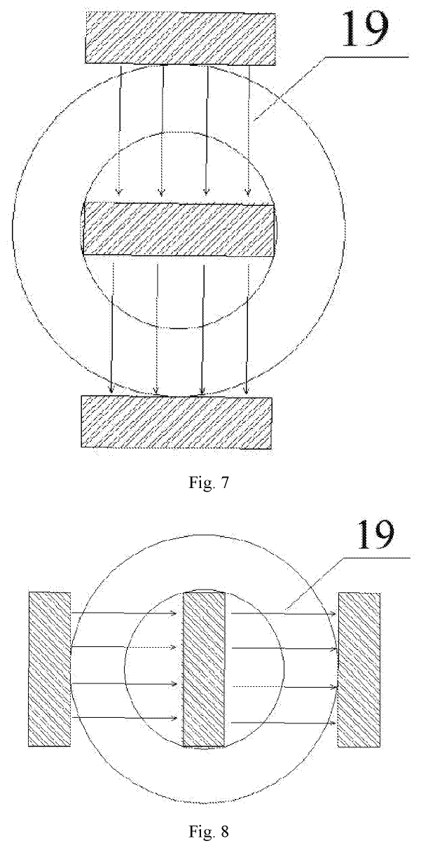

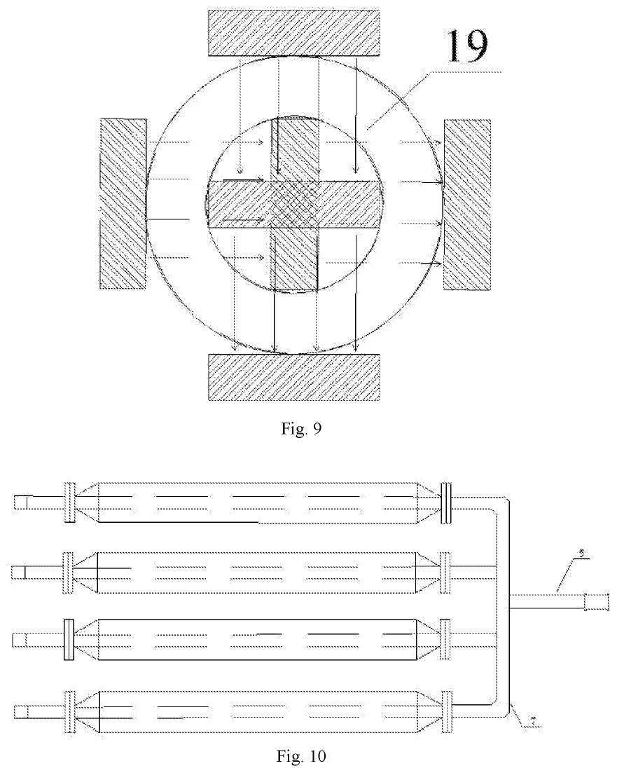

B. the hollow pressure pipe 15, the spiral blade 16 and the pressure pipe 2 build a screw-propelled water magnetizing channel to uniformly magnetize the water; and a magnetic field environment 19 formed by the internal magnet 13 and the external magnet 12 in a staggered arrangement manner and having alternate intensity performs continuous pulse cutting magnetization to water; (as shown in FIGS. 7-9)

C. the water for dust fall outflows through the water outlet 5.

The intensity of the magnetic field environment 19 formed by the internal magnet and the external magnet is 300 mT-350 mT.

The screw-propelled water magnetizing channel formed by the hollow pressure pipe 15, the spiral blade 16 and the pressure pipe 2 increases the turbulence and magnetic course of the water solution when compared with the straight-through magnetizing channel; the alternate pulse magnetic field environment 19 formed by the internal magnet 13 and the external magnet 12 in a staggered arrangement manner can enable the water molecule and the magnetic field to form a resonance system when compared to a single magnetic field environment, thereby aggravating the molecular motion in the solution, facilitating the breakage of intermolecular hydrogen bonds in the solution, achieving the efficient and uniform magnetization of the water for dust fall, and enhancing the spray and dust fall effect of the solution.

### Embodiment II

Different from Embodiment I, as shown in FIG. 10, the number of the magnetic drum 1 of Embodiment is eight, and four magnetic drums 1 are located in the first row; and one end of the first row of four magnetic drums 1 is respectively connected to the connecting elbow 7 through their flange plates 3, and the connecting elbow 7 is connected to the water outlet 5.

The above-mentioned embodiments are only preferred embodiments of the disclosure. It should be pointed out that, those ordinary in the art could make several improvements on the premise of not departing from the principle of the disclosure, and these improvements should also be regarded as the protection scope of the disclosure.

1. A magnetizing device for preparing magnetized water for dust fall of an underground coal mine, comprising a magnetic drum (1), a water outlet (5) and a water inlet (9), wherein the magnetic drum (1) comprises a pressure pipe (2), a flange plate (3), an external magnet (12), an internal magnet (13), a hollow pressure pipe (15), a spiral blade (16), a connecting steel column (18) and a closed nut (17);
The flange plate (3) is welded at the two ends of the magnetic drum (1); the pressure pipe (2) is connected to the water outlet (5) and the water inlet (9) through the flange plate (3) respectively; and the water outlet (5) and the water inlet (9) are connected to a water inlet and outlet pipe for dust fall respectively;
The external magnet (12) is arranged on the outer wall of the pressure pipe (2); the outer walls at the two ends of the hollow pressure pipe (15) are fixed with the inner wall of the pressure pipe (2) through the connecting steel column (18) by welding; the spiral blade (16) is pasted on the inner wall of the pressure pipe (2), and welded with the hollow pressure pipe (15); and the internal magnet (13) is closed inside the hollow pressure pipe (15), and the two ends of the hollow pressure pipe (15) are closed with the closed nut (17).

2. The magnetizing device for preparing magnetized water for dust fall of the underground coal mine according to claim 1, wherein the magnetic drum (1) is n (plural), and divided into two rows; the water outlet (5) is connected to one end of each of the first row of magnetic drums (1) through a first connecting elbow (7); the water inlet (9) is connected to one end of each of the second row of magnetic drums (1) through a second connecting elbow (7); the other end of each of the first row of magnetic drums (1) is respectively connected to the other end of each of the second row of magnetic drums (1) through one connecting elbow (7), and the magnetic drums are arranged in a “U”-shaped manner in parallel; and valves (4, 8, 10, 11) are arranged at one end of the magnetic drum (1) connected to the water outlet (5) and the water inlet (9) through the connecting elbow (7).

3. The magnetizing device for preparing magnetized water for dust fall of the underground coal mine according to claim 1, wherein the number n of the magnetic drum (1) is more than or equal to 4, and is an even number; and the magnetic drum (1) has a length of 1.3 m to 1.8 m.

4. The magnetizing device for preparing magnetized water for dust fall of the underground coal mine according to claim 1, wherein the thread pitch d of the spiral blade (16) is more than or equal to 50 mm, and the spiral blade is welded with the hollow pressure pipe (15) in a closed manner.

5. The magnetizing device for preparing magnetized water for dust fall of the underground coal mine according to claim 1, wherein the hollow pressure pipe (15) is made of 304# stainless steel and welded with the pressure pipe (2) by virtue of the “V”-shaped connecting steel column (18); the internal threads are provided at the two ends of the hollow pressure pipe (15), and closed with the closed nut (17); and the pressure pipe (2) is made of 304# stainless steel.

6. The magnetizing device for preparing magnetized water for dust fall of the underground coal mine according to claim 1, wherein the outer wall of the pressure pipe (2) is wrapped by a magnetic shield cover (14) and the external magnet (12) is located between the magnetic shield cover (14) and the pressure pipe (2).

7. The magnetizing device for preparing magnetized water for dust fall of the underground coal mine according to any of claim 1, wherein the external magnet (12) is arranged around the pressure pipe (2) alternately; and the internal magnet (13) is closed in the hollow pressure pipe (15) and arranged in a crisscross manner.

8. A magnetizing method using the magnetizing device for preparing magnetized water for dust fall of the underground coal mine according to claim 7, comprising the following steps:
A. water for dust fall is fed in the water inlet (9) and flowed into the pressure pipe (2), and water flow is controlled by controlling the valves (4, 8, 10, 11);
B. the hollow pressure pipe (15), the spiral blade (16) and the pressure pipe (2) build a screw-propelled water magnetizing channel to uniformly magnetize the water; and a magnetic field environment (19) formed by the internal magnet (13) and the external magnet (12) in a staggered arrangement manner and having alternate intensity performs continuous pulse cutting magnetization to water; and the water for dust fall outflows through the water outlet (5).

9. The magnetizing method according to claim 8, wherein the intensity of the magnetic field environment (19) formed by the internal magnet (13) and the external magnet (12) is 300 mT-350 mT.

10. The magnetizing device for preparing magnetized water for dust fall of the underground coal mine according to any of claim 2, wherein the external magnet (12) is arranged around the pressure pipe (2) alternately; and the internal magnet (13) is closed in the hollow pressure pipe (15) and arranged in a crisscross manner.

11. The magnetizing device for preparing magnetized water for dust fall of the underground coal mine according to any of claim 3, wherein the external magnet (12) is arranged around the pressure pipe (2) alternately; and the internal magnet (13) is closed in the hollow pressure pipe (15) and arranged in a crisscross manner.

12. The magnetizing device for preparing magnetized water for dust fall of the underground coal mine according to any of claim 4, wherein the external magnet (12) is arranged around the pressure pipe (2) alternately; and the internal magnet (13) is closed in the hollow pressure pipe (15) and arranged in a crisscross manner.

13. The magnetizing device for preparing magnetized water for dust fall of the underground coal mine according to any of claim 5, wherein the external magnet (12) is arranged around the pressure pipe (2) alternately; and the internal magnet (13) is closed in the hollow pressure pipe (15) and arranged in a crisscross manner.

14. The magnetizing device for preparing magnetized water for dust fall of the underground coal mine according to any of claim 6, wherein the external magnet (12) is arranged around the pressure pipe (2) alternately; and the internal magnet (13) is closed in the hollow pressure pipe (15) and arranged in a crisscross manner.
